(19) United States
(12) Patent Application Publication
(10) Pub. No.: US 2014/0301592 A1
(43) Pub. Date: Oct. 9, 2014

(54) EAR PAD AND EARPHONE DEVICE

(71) Applicant: FUNAI ELECTRIC CO., LTD., Osaka (JP)

(72) Inventor: Fuminori TANAKA, Osaka (JP)

(73) Assignee: FUNAI ELECTRIC CO., LTD., Osaka (JP)

(21) Appl. No.: 14/228,558

(22) Filed: Mar. 28, 2014

(30) Foreign Application Priority Data
Apr. 8, 2013 (JP) 2013-080605

(51) Int. Cl. H04R 1/10

(52) U.S. Cl. CPC H04R 1/1016
USPC 381/380

(57) ABSTRACT

An ear pad that is an elastic member and fitted over a protrusion on an earphone device includes a main body having a hollow in which the protrusion fits, wherein the main body has, at an end, a surface having an opening communicating with the hollow, and the surface has a recess formed in a radial direction from a center of the surface toward an outside of the main body.

### CROSS REFERENCE TO RELATED APPLICATION

The present application is based on and claims priority of Japanese Patent Application No. 2013-080605 filed on Apr. 8, 2013. The entire disclosure of the above-identified application, including the specification, drawings and claims is incorporated herein by reference in its entirety.

### FIELD

The present invention relates to an ear pad and an earphone device which uses the ear pad.

### BACKGROUND

Patent Literature 1 discloses conventional intra-concha earphone devices. An earphone device of this type includes an ear pad at a portion which fits in an ear, in order to improve the fit thereto.

FIG. 8 illustrates a conventional earphone device. As illustrated in FIG. 8, a cylindrical protrusion 20 is formed on a conventional earphone device 2, and has a sound hole for passing sound. The earphone device 2 is used being fitted in the ear of a user. The protrusion 20 is fitted in an opening 100A of the ear pad 100, thereby attaching the ear pad 100 to the earphone device 2, in order to improve the fit to the ear in the above state.

As described above, the protrusion 20 of the earphone device 2 is inserted into an ear in a state where the ear pad 100 is attached, thereby allowing the user to wear the earphone device 2. This ear pad 100 allows the earphone device 2 to be tightly fitted in the ear.

However, the diameter of the protrusion 20 is formed so as to be greater than the diameter of the opening 100A of the ear pad 100 in order that the ear pad 100 is firmly attached over the protrusion 20, which leads to a problem that the ear pad 100 is not readily fitted over the protrusion 20.

### CITATION LIST

### Patent Literature

[PTL 1] Japanese Unexamined Patent Application Publication No. 2010-81306

### SUMMARY

### Technical Problem

Accordingly, a groove is currently formed in a protrusion to allow the ear pad to be easily fitted over. Alternatively, the ear pad is manufactured using a highly elastic material.

However, if a groove is formed in a protrusion, the thickness of the protrusion decreases by the formed groove, and thus the rigidity of the protrusion falls. In addition, the sound hole is decreased by the formed groove, which limits a speaker which can be embedded. To manufacture an ear pad using a highly elastic material, however, costs a lot.

The present invention has been conceived in order to solve the above problems, and an object thereof is to provide a low-cost ear pad easily attachable over a protrusion of an earphone device, while securing the robustness of the protrusion.

### Solution to Problem

In order to achieve the above object, an ear pad according to an aspect of the present invention is an ear pad that is an elastic member and fitted over a protrusion on an earphone device, the ear pad including a main body having a hollow in which the protrusion fits, wherein the main body has, at an end, a surface having an opening communicating with the hollow, and the surface has at least one recess formed in a radial direction from a center of the surface toward an outside of the main body.

According to this configuration, an ear pad is an elastic member having a hollow, a surface is formed at an end of the main body of the ear pad, and the surface has at least one recess formed in a radial direction from a center of the surface toward an outside of the main body. Thus, the diameter of the opening along the center line easily increases when the main body is compressed inward from the outside.

As a result, the ear pad is easily fitted over the protrusion of the earphone device. In addition, the ear pad is an elastic member, thus preventing the ear pad to be dropped from the ear and improving the hold of the earphone device.

In such a manner, by merely making the ear pad using an elastic member and providing a recess in the surface at an end of the main body in a direction from the center of the surface toward the outside of the main body, rather than processing the protrusion of the earphone device, the ear pad is allowed to be easily attached over the protrusion of the earphone device. Thus, an ear pad easily attachable over the protrusion can be provided at a low cost while securing the robustness of the protrusion of the earphone device.

The protrusion of the earphone device may have a cylindrical shape, and the opening may have a space in a direction crossing a center line on the surface when the main body is compressed with the at least one recess being positioned on the center line so that a diameter of the opening along the center line is equal to a diameter of an end of the protrusion, the center line passing through the center of the surface.

According to this configuration, the opening is not closed when the main body is compressed with at least one recess being positioned on a center line on the surface in a diameter direction of the surface so that the diameter of the opening along the center line is equal to the diameter of an end of the protrusion, the center line passing through the center of the surface. Thus, the diameter of the opening along the center line can be made equal to the diameter of an end of the protrusion, and the protrusion can be inserted into the opening, which allows the ear pad to be still more easily attached over the protrusion of the earphone device.

The at least one recess in the surface may include two recesses opposite each other on a center line on the surface, the center line passing through the center of the surface.

According to this configuration, the surface has two recesses opposite each other on the center line of the surface, and thus the main body can be still more easily compressed with the recesses being positioned on the center line of the surface.

The at least one recess in the surface may further include two recesses opposite each other on a cross line on the surface, the cross line crossing the center line.

According to this configuration, the surface has four recesses, which allows the main body to be compressed in at least two directions. Therefore, the ear pad can be still more easily attached over the protrusion of the earphone device.

The four recesses may be provided in the surface at 90 degree intervals about the center of the surface.

According to this configuration, the surface has recesses at 90 degree intervals about the center of the surface, and thus the main body can be compressed in both lateral and vertical directions. Thus, the user can compress the main body without being aware of whether the direction is the lateral or vertical direction of the ear pad, which allows the ear pad to be still more easily attached over the protrusion.

In addition, an earphone device according to another aspect of the present invention includes the ear pad described above, and thus the above effects can be produced.

### Advantageous Effects

According to the present invention, a low-cost ear pad easily attachable over a protrusion can be provided while securing the robustness of the protrusion of an earphone device.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 illustrates an earphone device according to an embodiment of the present invention in a state prior to when an ear pad is attached.

FIG. 2 is a fragmentary perspective view of a portion which includes a protrusion of the earphone device according to the embodiment of the invention.

FIG. 3 is a front cross-sectional view of the ear pad according to the embodiment of the invention.

FIG. 4A is a lateral cross-sectional view for describing connection between the earphone device and the ear pad, and illustrates a state prior to fitting the ear pad over the earphone device.

FIG. 4B is a lateral cross-sectional view for describing connection between the earphone device and the ear pad, and illustrates a state posterior to fitting the ear pad over the earphone device.

FIG. 5 is a front cross-sectional view of an ear pad, where (a) of FIG. 5 illustrates a state where no force is applied to a main body, and (b) of FIG. 5 illustrates a state where force is applied to the main body in the lateral direction.

FIG. 6 is a front cross-sectional view illustrating another example of a configuration of the ear pad according to the embodiment of the present invention, where (a) of FIG. 6 illustrates a state where no force is applied to the main body, and (b) of FIG. 6 illustrates a state where force is applied to the main body in the lateral direction.

FIG. 7 is a front cross-sectional view illustrating still another example of the configuration of the ear pad according the embodiment of the invention, where (a) of FIG. 7 illustrates a state where no force is applied to the main body, and (b) of FIG. 7 illustrates a state where force is applied to the main body in the lateral direction.

FIG. 8 illustrates a conventional earphone device.

### DESCRIPTION OF EMBODIMENTS

### Embodiment 1

The following describes in detail embodiments of the present invention using drawings. It should be noted that the exemplary embodiments described below each show a preferable, specific example. The shapes, materials, constituent elements, the arrangement and connection of the constituent elements, and others indicated in the following exemplary embodiments are mere examples, and are not intended to limit the inventive concept. The present in is defined by the claims. Therefore, although a constituent element which is included in the constituent elements in the embodiments below and is not described in independent claims each showing the broadest concept of the present invention is not necessarily needed to achieve the object of the present invention, such a constituent element will be described for the description of a more preferred configuration.

### <Configurations of Earphone Device and Ear Pad>

In the following description, an X axial direction represents the lateral direction of an earphone device and an ear pad, a Y axial direction represents the front direction thereof, and a Z axial direction represents the upper direction thereof.

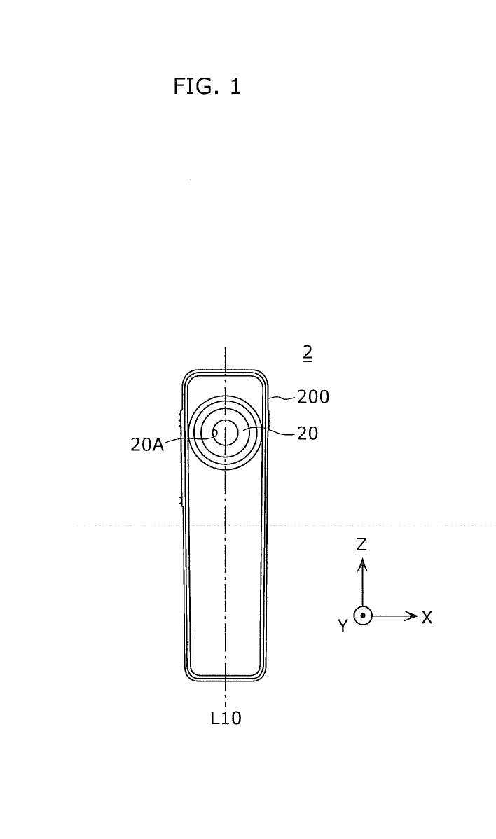

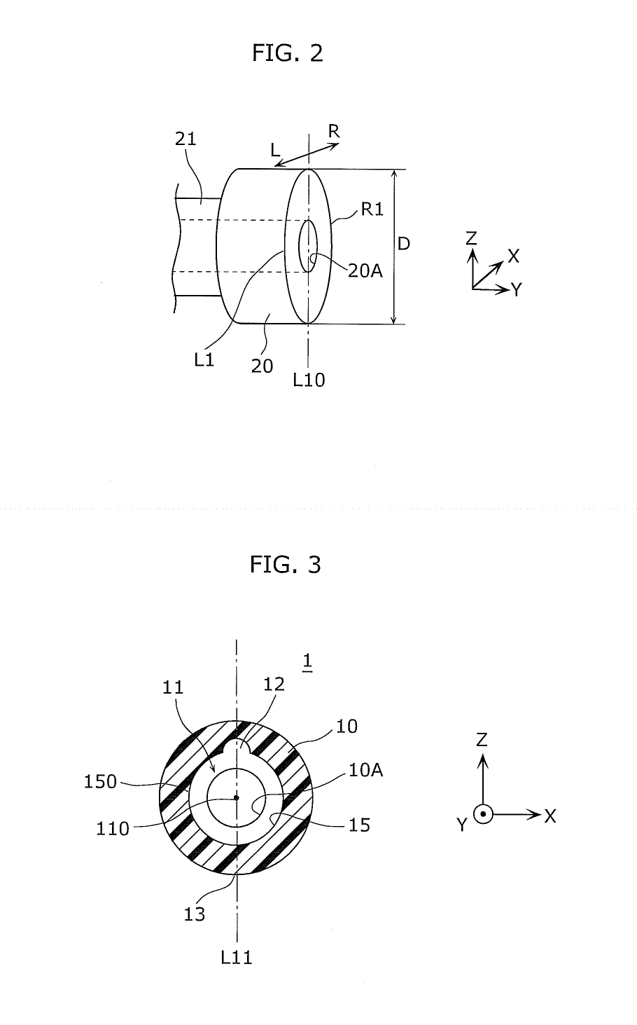

FIG. 1 illustrates an earphone device according to Embodiment 1 of the present invention, and illustrates a state prior to attaching an ear pad. FIG. 2 is a fragmentary perspective view of a portion which includes a protrusion of the earphone device according to Embodiment 1 of the present invention. It should be noted that in FIG. 2, L represents the left side, whereas R represents the right side. FIG. 3 is a front cross-sectional view of the ear pad according to Embodiment 1 of the present invention.

An earphone device 2 illustrated in FIG. 1 has a similar configuration to that described in the Background section. The earphone device 2 includes an earphone main body 200. The earphone main body 200 includes a speaker not illustrated in the drawings. In addition, a sound hole 20A is formed in the earphone main body 200, and sound from the speaker is led outside via the sound hole 20A.

The earphone device 2 wirelessly communicates with a mobile phone of a person wearing the earphone device 2 using, for example, Bluetooth (registered trademark) which is one short-distance radio telecommunications standard, and outputs from the speaker sound received from the other person's phone (a mobile or fixed-line phone).

As illustrated in FIGS. 1 and 2, the earphone main body 200 includes a protrusion 20 for an ear pad 1 to fit over. The protrusion 20 is supported on the surface of the earphone main body 200 by a support member 21. As illustrated in FIGS. 1 and 2, the protrusion 20 and the sound hole 20A are provided symmetrically relative to a center line L10.

As illustrated in FIG. 3, the ear pad 1 includes a main body 10 that is an elastic member such as rubber. The main body 10 has a hollow 11 formed symmetrically relative to a center line L11 in the height direction.

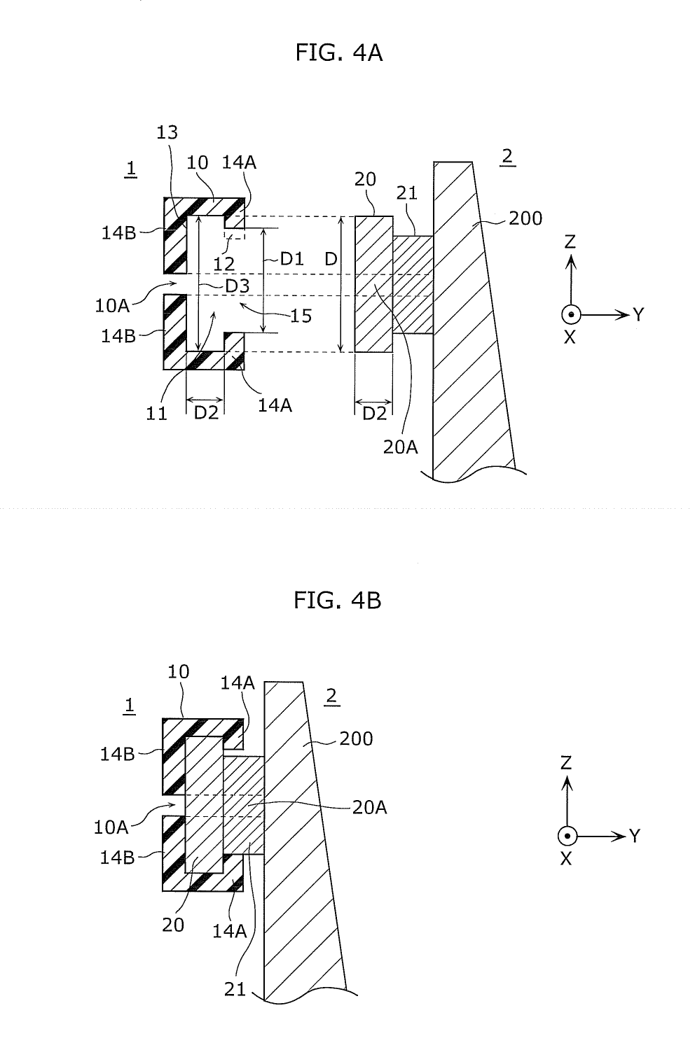

FIGS. 4A and 4B are lateral cross-sectional views for describing the connection between the earphone device and the ear pad. FIG. 4A illustrates a state prior to fitting the ear pad 1 over the earphone device 2, and FIG. 4B illustrates a state posterior to fitting the ear pad 1 over the earphone device 2.

As illustrated in FIG. 4, a diameter D3 of the hollow 11 is formed so as to be greater than a diameter D1 of an opening 15. In addition, the hollow 11 and the protrusion 20 are formed such that a length D2 of the hollow 11 in the front direction is the same as a length D2 of the protrusion 20 in the front direction. In this manner, when the ear pad 1 is fitted over the protrusion 20 of the earphone device 2, the protrusion 20 firmly fits in the hollow 11, which prevents the ear pad 1 from detaching from the protrusion 20.

The opening 15 which leads to the hollow 11 is formed at an end of the main body 10, as illustrated in FIGS. 3 and 4A. By forming the opening 15, a surface 150 having the opening 15 is formed at an end of the main body 10. The opening 15 is formed concentrically with the main body 10 in the surface 150.

In the surface 150, as illustrated in FIG. 3, a recess 12 is provided in a radial direction from a center 110 of the surface 150 toward the outside of the main body 10. In contrast, the other end of the main body 10 (an end portion in which the surface 150 is not provided) includes a bottom portion 13 of the hollow 11, and a sound hole 10A is formed in the center of the bottom portion 13, as illustrated in FIGS. 3, 4A, and 4B.

As illustrated in FIG. 4A, the main body 10 includes a protrusion-side wall 14A on the protrusion 20 side of the earphone device 2 and an ear-side wall 14B on the user's ear side. The sound hole 10A is provided in the center (the center of the bottom portion 13) of the ear-side wall 14B. In contrast, the protrusion-side wall 14A includes a notch as the recess 12, at an upper portion of the protrusion-side wall 14A.

### <Attachment of Ear Pad to Earphone Device>

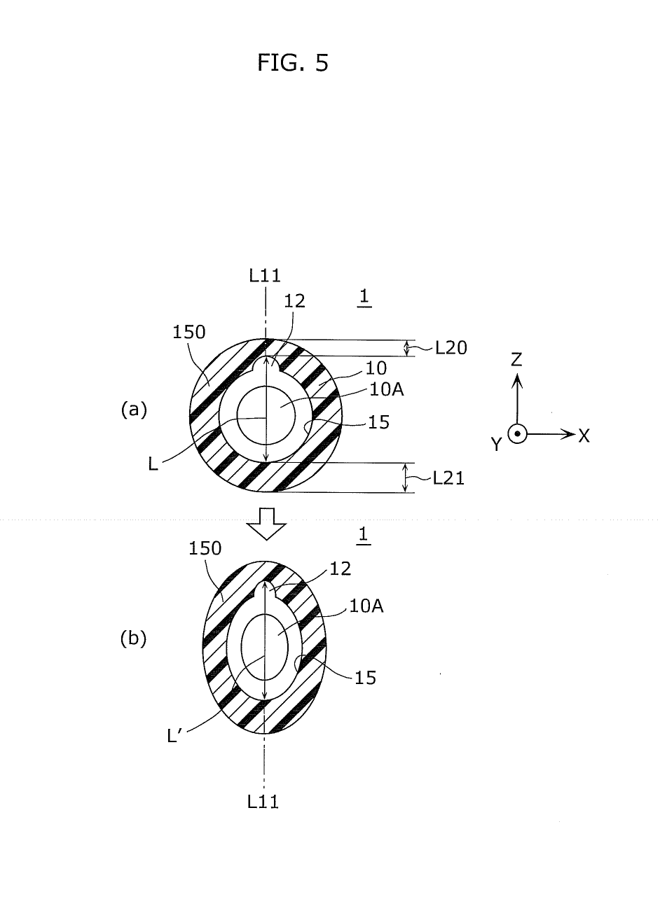

The following describes steps of attaching the ear pad 1 to the earphone device 2, using FIGS. 2 to 5. FIG. 5 is a front cross-sectional view of the ear pad 1, where (a) of FIG. 5 illustrates a state where no force is applied to the main body 10, and (b) of FIG. 5 illustrates a state where force is applied to the main body 10 in the lateral direction.

The main body 10 and the opening 15 are cylindrical as illustrated in (a) of FIG. 5 when no force is applied to the main body 10. In such a state, the diameter D1 of the opening 15 remains a diameter L.

When the main body 10 is compressed with the recess 12 being positioned on the center line L11 on the surface 150, which passes through the center 110 of the surface 150 in the diameter direction of the surface 150, or in other words, here, when force is laterally applied to the main body 10, the main body 10 and the opening 15 tend to elongate in a direction perpendicular to the direction in which force is applied, or specifically, to elongate in the height direction.

At that time, the surface 150 has the recess 12 in the radial direction from the center 110 of the surface 150 toward the outside of the main body 10, and a length L20 of the main body 10 on a side where the recess 12 is provided is smaller than a length L21 of the main body 10 on a side where the recess 12 is not provided. Thus, the diameter D1 of the opening 15 changes to at least a diameter L′ greater than the diameter L, as illustrated in (b) of FIG. 5.

Thus, when fitting the ear pad 1 over the protrusion 20 of the earphone device 2, first, the user pinches the lateral sides of the main body 10 of the ear pad 1 with two fingers, and squeezes the ear pad 1. Then, the diameter D1 of the opening 15 along the center line L11 increases to the diameter L′ greater than the diameter L. Thus, in that state, the user brings the main body 10 onto the protrusion 20 such that one of a left edge L1 and a right edge R1 of the protrusion 20 is positioned at the opening 15.

Then, in that as-is state, the user applies force to the main body 10 in a direction toward one of the left edge L1 and the right edge R1 of the protrusion 20, and inserts the protrusion into the opening 15, from the one of the left edge L1 and the right edge R1 up to the center line L10. In other words, the left or right half of the protrusion 20 is inserted in the opening 15.

Then, the length of the opening 15 in the lateral direction is increased by the inserted protrusion 20, and then the user inserts the remaining portion (other edge side) of the protrusion 20 into the expanded portion. As a result, the diameter D3 of the hollow 11 is formed so as to be greater than the diameter D1 of the opening 15, and thus the protrusion 20 of the earphone device 2 is fitted firmly in the hollow 11, as shown in FIG. 4B.

As described above, the surface 150 of the ear pad 1 has a single recess 12 formed in the direction passing through the center 110 of the surface 150 toward the outside of the main body 10 along the diameter of the surface 150. Thus, when the main body 10 is squeezed in the lateral direction, the diameter D1 of the opening 15 along the center line L11 easily increases.

This allows the protrusion 20 of the earphone device 2 to be easily inserted into the hollow 11 of the ear pad 1. In addition, the main body 10 is an elastic member such as rubber, thus achieving cost reduction and the fit to an ear.

In addition, no processing is performed on the protrusion 20 of the earphone device 2, and a conventional one is used, thus achieving cost reduction and securing robustness of the protrusion 20.

Thus, while securing the robustness of the protrusion 20 of the earphone device 2, the ear pad 1 which can be easily attached over the protrusion 20 can be provided at a low cost.

In addition, in the ear pad 1, the opening 15 is formed so as to have a space in a direction perpendicular to the center line L11, that is, in the lateral direction when the main body 10 is compressed with the recess 12 being positioned on the center line L11 of the surface 150 so that the diameter D1 of the opening 15 along the center line L11 is equal to a diameter D of an end of the protrusion 20.

In this manner, the opening 15 is not closed even if the main body 10 is compressed up to when the diameter D1 of the opening 15 is equal to the diameter D of the protrusion 20, thus allowing the ear pad 1 to be still more easily attached to the protrusion 20 of the earphone device 2.

### Embodiment 2

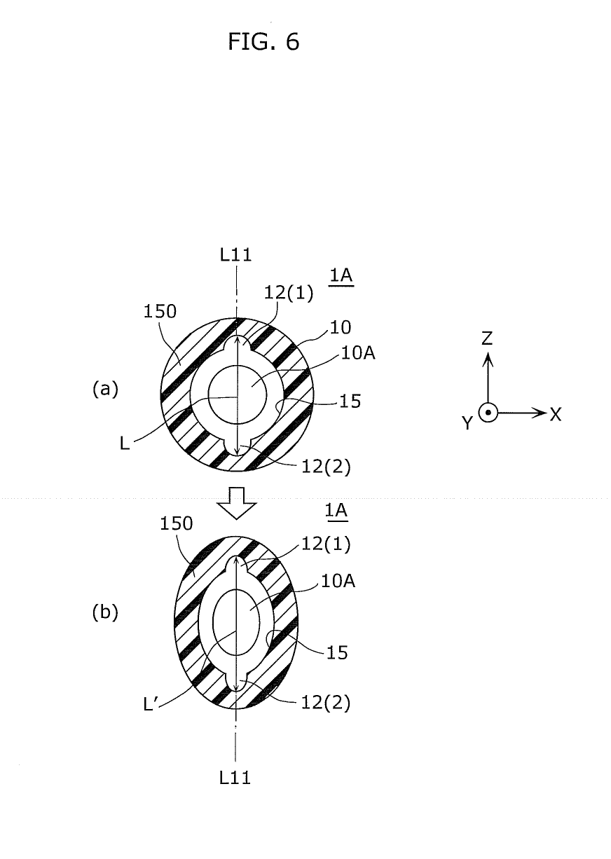

FIG. 6 is a front cross-sectional view illustrating another example of a configuration of an ear pad according to Embodiment 2 of the present invention. In an ear pad 1A, a surface 150 has two recesses 12 (1) and 12 (2) opposite each other on a center line L11 of the surface 150.

According to this configuration, due to the two recesses 12 (1) and 12 (2), the number of portions in which the diameter of a main body 10 along the center line L11 decreases is greater than the case where a single recess is provided, and the length D1 of an opening 15 in the diameter direction easily extends when the main body 10 is compressed in a lateral direction. As a result, this allows the ear pad 1A to be still more easily attached over a protrusion 20 of an earphone device 2.

### Embodiment 3

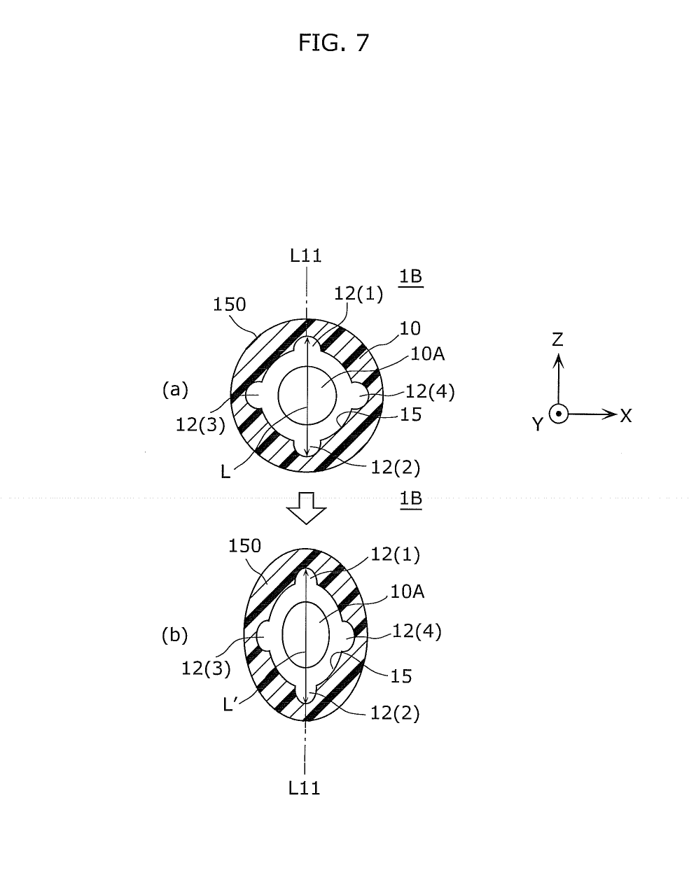

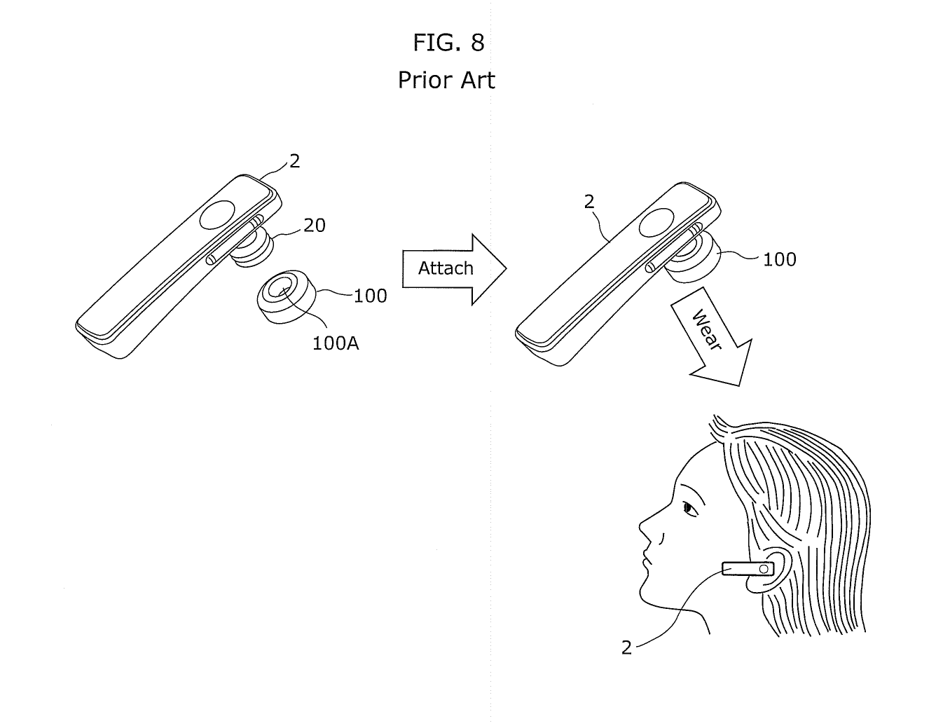

FIG. 7 is a front cross-sectional view illustrating sill another example of a configuration of an ear pad according to Embodiment 3 of the present invention. In the ear pad 1B, four recesses 12 (1) to 12 (4) are provided in a surface 150 at 90 degree intervals about a center 110 of the surface 150.

According to this configuration, compared to the case where two recesses are provided, the recesses 12 (3) and 12 (4) are further provided, and thus the main body 10 can be compressed not only in a lateral direction, but also in a vertical direction. Thus, an opening 15 extends not only in a vertical direction but in a lateral direction, thus allowing an ear pad 1 to be still more easily attached over a protrusion 20 of an earphone device 2.

It should be noted that although the recesses 12 (1) to 12 (4) are provided at 90 degree intervals about the center 110 of the surface 150 according to Embodiment 3, the ear pad according to the present application is not limited to the above example. For example, the main body 10 may have two more recesses opposite each other on a line that crosses a center line L11 of the surface 150, in a radial direction from the center 110 of the surface 150 toward the outside of the main body 10. This configuration also allows the opening 15 to extend in two directions, which allows the ear pad 1 to be easily attached over the protrusion 20 of the earphone device 2.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable to, for example, an earphone device of a hands-free mobile phone with which a user can talk with another person, as an ear pad and an earphone device.

1. An ear pad that is an elastic member and fitted over a protrusion on an earphone device, the ear pad comprising
a main body having a hollow in which the protrusion fits,
wherein the main body has, at an end, a surface having an opening communicating with the hollow, and
the surface has at least one recess formed in a radial direction from a center of the surface toward an outside of the main body.

2. The ear pad according to claim 1,
wherein the protrusion of the earphone device has a cylindrical shape, and
the opening has a space in a direction crossing a center line on the surface when the main body is compressed with the at least one recess being positioned on the center line so that a diameter of the opening along the center line is equal to a diameter of an end of the protrusion, the center line passing through the center of the surface.

3. The ear pad according to claim 1,
wherein the at least one recess in the surface includes two recesses opposite each other on a center line on the surface, the center line passing through the center of the surface.

4. The ear pad according to claim 3,
wherein the at least one recess in the surface further includes two recesses opposite each other on a cross line on the surface, the cross line crossing the center line.

5. The ear pad according to claim 4,
wherein the four recesses are provided in the surface at 90 degree intervals about the center of the surface.

6. An earphone device which includes the ear pad according to claim 1.
